(19) United States
(12) Patent Application Publication
(10) Pub. No.: US 2020/0270904 A1
(43) Pub. Date: Aug. 27, 2020

(54) Electronic Mortise Lock

(71) Applicant: Nexkey, Inc., San Mateo, CA (US)

(72) Inventors: Chi (Ricky) Lee, Emeryville, CA (US); William J. Rehlich, San Francisco, CA (US); Peter R. Russo, Oakland, CA (US)

(21) Appl. No.: 16/799,445

(22) Filed: Feb. 24, 2020

Related U.S. Application Data
(60) Provisional application No. 62/810,292, filed on Feb. 25, 2019.

(51) Int. Cl. E05B 47/00; E05B 9/04; E05B 17/10; E05B 1/00; G07C 9/00

(52) U.S. Cl. CPC E05B 47/0012; E05B 9/04; E05B 17/10; E05B 1/003; E05B 1/0038; G07C 2009/0019; E05B 2047/0091; E05B 2047/0058; E05B 2009/046; E05B 2009/047; G07C 9/00182

(57) ABSTRACT

A lock and method for locking wherein the lock includes a cylindrical housing that houses at least a replaceable battery, a lock mechanism, an electronic circuit powered by the replaceable battery, the electronic circuit being configured to authenticate a user and electro-mechanically actuate the lock mechanism of the lock responsive to being activated, and a rotor coupled to the lock mechanism of the lock, the rotor being powered by the replaceable battery and configured to situate the lock mechanism based on a lock state of the lock, and a handle situated outside the cylindrical housing on a front side of the cylindrical housing, the handle being coupled to the lock mechanism, the handle being configured to activate the lock responsive to the user moving the handle.

### CROSS REFERENCE TO RELATED APPLICATIONS

This application claims priority to U.S. Provisional Patent Application No. 62/810,292, filed Feb. 25, 2019, which is incorporated by reference herein in its entirety.

### TECHNICAL FIELD

The present disclosure relates to lock mechanisms.

### BACKGROUND

Purely mechanical key-actuated locks are ubiquitously used in residential and commercial applications. As Internet-of-Things (IoT) devices have gained popularity, and their component costs have decreased, people are considering replacing mechanical locks with electronic locks in commercial and residential applications due to the flexibility, ease of use, and other advantages that current electronic locks have over conventional mechanical ones. However, existing electronic locks have a number of issues preventing rapid and/or widespread adoption.

For instance, existing electronic locks are bulky/larger in size and/or are often difficult and expensive to install as a retrofit into existing doors. Further, existing electronic locks often require wired power sources (e.g., an alternating current (AC) feed), which may require hiring an electrician to run the wiring.

Additionally, in general, factors that determine the specifications for the general shape and size of electronic circuitry of existing electronic locks have prevented the creation of very small electronic locks that are convenient to use in retrofit applications, and are smart (e.g., are wirelessly accessible and can perform computing functions) energy efficient, and low maintenance.

Depending on the application, such smart locks should also be capable of being weatherproof and tamperproof to prevent failure in extreme weather conditions, and provide robust security protection of the individuals and/or assets they are intended to secure.

### SUMMARY

The present disclosure describes, among other things, various aspects for an innovative electronic mortise lock and method. The lock may in some embodiments comprise a smart lock having enhanced features, such as wireless unlocking, cryptographic authentication, low power consumption, etc. The lock may, in some cases, advantageously be a drop-in replacement/retrofit for a traditional mortise lock.

One general aspect includes a lock comprising: a cylindrical housing and a handle. The cylindrical housing houses at least: a replaceable battery, a lock mechanism, an electronic circuit powered by the replaceable battery, and a rotor. The electronic circuit being configured to authenticate a user and electro-mechanically actuate the lock mechanism of the lock responsive to being activated. The rotor coupled to the lock mechanism of the lock, with the rotor being powered by the replaceable battery and configured to situate the lock mechanism based on a lock state of the lock. The handle is situated outside the cylindrical housing on a front side of the cylindrical housing, with the handle being coupled to the lock mechanism, the handle being configured to activate the lock responsive to the user moving the handle.

Implementations may include one or more of the following features. The lock wherein the lock state includes one of: an unlocked state where the rotor turns the lock mechanism to an unlocked position, a locked state where the rotor turns the lock mechanism to a locked position, and an intermediate state where the rotor is temporarily situated between the locked state and the unlock state. The lock wherein the intermediate state is bi-stable. The lock wherein a proximal end of the cylindrical housing includes a front surface of the lock, the front surface including an electronic indicator indicating a lock state of the lock, the electronic indicator being coupled to the electronic circuit, the front surface further including an aperture through which the handle is coupled to a core of the cylinder, the cylindrical housing includes a cylindrical cavity at a distal end that houses subcomponents of the lock including the replaceable battery, the locking mechanism, the rotor, and at least a portion of the electronic circuit, and the subcomponents housed by the cylindrical housing are inaccessible from the proximal end and accessible from the distal end.

Other implementations include a loc wherein the front surface includes a light aperture, and the electronic indicator is oriented in the cylindrical housing by an alignment mechanism such that the electronic indicator emits light through the light aperture. The lock wherein responsive to the user moving the handle, the electronic circuit activates the electronic indicator to indicate one of a locked state of the lock and an unlocked state of the lock. The lock wherein the cylindrical housing further houses a switch situated adjacent to the lock mechanism, and to activate the lock, the handle is inwardly movable relative to the front side to activate the switch of the electronic circuit. The lock wherein the lock mechanism comprises a spring-loaded core, the handle is coupled to a first end of the spring loaded core, and pressing the handle inwardly creates a contact between the core and a switch of the electronic circuit to activate the lock. The lock wherein at least a portion of the electronic circuit includes a circuit board having a protruding alignment tab that self-aligns the electronic circuit when inserted into the cylindrical housing.

Another general aspect includes a method of lock actuation comprising tapping a handle of a lock in a locked state, wherein tapping the handle activates the lock for operation; wirelessly transmitting an authentication request to a user device by the lock, the authentication request triggering a response that confirms the identity of a user as an authorized user of the lock; and wirelessly receiving an authentication response from the user device by the lock, the authentication response electromechanically unlocking the lock.

Implementations may include one or more of the following features. The method further comprises turning the lock mechanism by a rotor to an unlocked position, turning the lock mechanism by the rotor to a locked position, and temporarily maintaining the rotor in an intermediate state between the locked state and the unlock state. The method wherein the intermediate state is bi-stable. The method further comprises indicating a lock state of the lock using an electronic indicator, the electronic indicator being responsive to an electronic circuit. The method further comprises emitting light through a light aperture on a front surface of the cylindrical housing. The method further comprises responsive to the user moving the handle, activating the electronic indicator to indicate one of the locked state of the lock and the unlocked state of the lock. The method further comprises inwardly moving the handle relative to the front side to activate a switch of the electronic circuit to activate the lock. The method further comprises pressing the handle inwardly to create a contact between a spring loaded core and a switch of the electronic circuit; and activating the lock in response to the contact. The method further comprises self-aligning an electronic circuit when inserted into a cylindrical housing.

Yet another general aspect includes a lock comprising a cylindrical housing and a handle. The cylindrical housing houses at least: a lock mechanism, an electronic circuit, the electronic circuit configured to authenticate a user and electro-mechanically actuate the lock mechanism of the lock responsive to being activated, and a rotor coupled to the lock mechanism of the lock, the rotor configured to situate the lock mechanism based on a lock state of the lock. The handle coupled to the lock mechanism to activate the lock responsive to the user moving the handle.

Other implementations include a lock wherein the lock state includes one of: an unlocked state where the rotor turns the lock mechanism to an unlocked position, a locked state where the rotor turns the lock mechanism to a locked position, and an intermediate state where the rotor is temporarily situated between the locked state and the unlock state.

The various embodiments advantageously apply the teachings of innovative electronic mortise lock and methods to provide an electronic lock of a generally reduced size that is easy to and relatively inexpensive to acquire and install and may further function to retrofit existing door locks. Further, existing electronic locks often require wired power sources (e.g., an alternating current (AC) feed), which may require hiring an electrician to run the wiring. The lock and method may further provide enhanced features of smart locks such as wireless unlocking, cryptographic authentication, low power consumption, etc. The lock may, in some cases, advantageously be a drop-in replacement/retrofit for a traditional mortise lock.

Accordingly, the embodiments disclosed herein provide various improvements to locks and locking methods.

It should be understood that language used in the present disclosure has been principally selected for readability and instructional purposes, and not to limit the scope of the subject matter disclosed herein.

### BRIEF DESCRIPTION OF THE DRAWINGS

FIGS. 1A-1E depicts various views of an example lock.

FIG. 2 depicts an exploded view of the lock.

FIG. 3 depicts a perspective view of an example shell component.

FIG. 4 depicts a rear view of the shell component of FIG. 3.

FIGS. 5A-5C depict an arrangement of an example spring cap in association with an exploded view of an insert subassembly.

FIG. 6 depicts a rear perspective view of an example subassembly.

FIGS. 7A-7D and 8A-8C depict views of an example motor housing.

FIGS. 8A-8C depict perspective views of an example rotor, motor, and motor housing.

FIGS. 9A-9D depict various views of the core housing of FIG. 5B.

FIG. 10A depicts a cutaway view of an example internal mechanism of a core housing containing a core and a locking pin.

FIG. 10B depicts a cutaway view of the lock showing the activation of the lock.

FIGS. 11A and 11B depict perspective views of an example housing subassembly.

FIGS. 12A and 12B depict views of an example spring cap.

FIG. 13 depicts a view of the spring cap of FIGS. 12A and 12B being coupled with the housing subassembly.

FIG. 14 depicts a view of an example PCB, battery, and a battery cap being coupled with a shell component.

FIGS. 15A and 15B depict perspective views of a coupling of an example core to a cam.

FIG. 16 is a flowchart of a method for lock actuation.

### DETAILED DESCRIPTION

The present disclosure relates to an innovative electronic mortise lock, although it should be understood that the structure and acts described herein may be applicable to other lock form factors in addition to a mortise form factor. The lock may in some embodiments comprise a smart lock having enhanced features, such as wireless unlocking, cryptographic authentication, low power consumption, etc. The lock may, in some cases, advantageously be a drop-in replacement/retrofit for a traditional mortise lock.

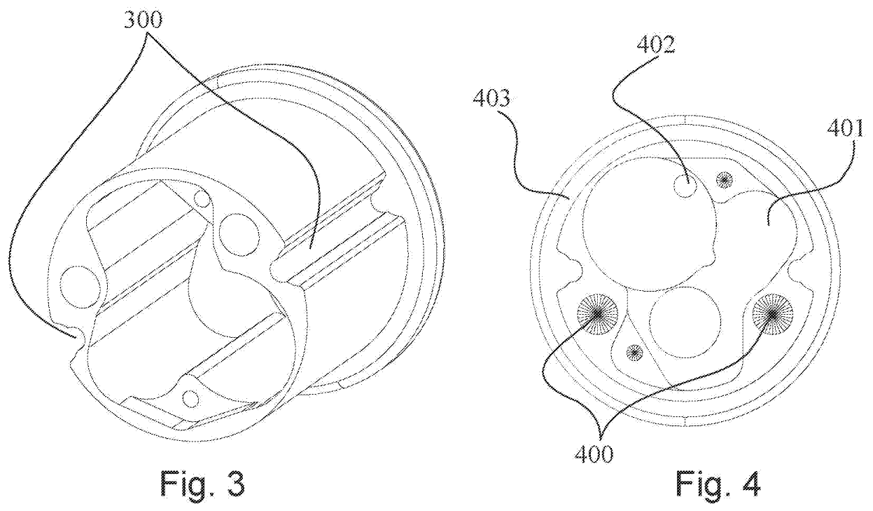

The mortise cylinder lock form factor generally requires a pocket (e.g. the mortise) to be cut into a door or other object (e.g., piece of furniture, etc.) into which the mortise cylinder is fitted. A slot 300 (shown in FIG. 3) may be cut on two sides of the external threads of the mortise cylinder for a set screw from a lock set to be used to restrict rotational movement once the lock is installed. In some embodiments, a rim cylinder (e.g., a lock that attaches to the surface of a door) could be substituted for the mortise cylinder. In this case, there may be two threaded holes on the back face of the rim cylinder thus making the concepts presented herein compatible in either case (mortise or rim, for example). Other applications and suitable form factors are also possible and contemplated.

As described in this document, the lock includes numerous novel features, such as, but not limited to; a push-to-wake mechanism that activates an internal switch at rear of housing by throwing spring-loaded core; a cylindrical housing that includes both external threads of a mortice as well as rim cylinder threaded holes on a back face; an electronic circuit (e.g., PCB) housed by the cylindrical housing; at least a portion of the electronic circuit self-aligns via integrated alignment tab; a light indicator (e.g., integrated LED) included in the electronic circuit to reflect a lock state; that at least a portion of the electronic circuit can be situated between a battery and an end of the cylindrical housing in an orientation dictated by the alignment tab; in an aligned position, the light indicator can emit light through a front face/surface of the lock; that at least the portion electronic circuit, when seated, can transfer power from battery to motor; a unique bi-stable configuration that allows the lock to operate in a bi-stable fashion; a lower profile; any suitable tail pieces can be used/are supported; being tamperproof and weatherproof; a concavely-shaped subassembly can accommodate an adjacently situated removable battery within cylindrical housing; a battery that can be replaced from the back of the lock, which increases security because the front can be made tamperproof (e.g., include fixed front-side component) and makes the lock more serviceable since not all of the components have to be removed from the housing to replace the battery; core cutouts and a sub-assembly component configuration that allow for secure pin retainment, movement of the pin, and for actuating pin/locking of lock; and a notch and locking pin that face the center of device.

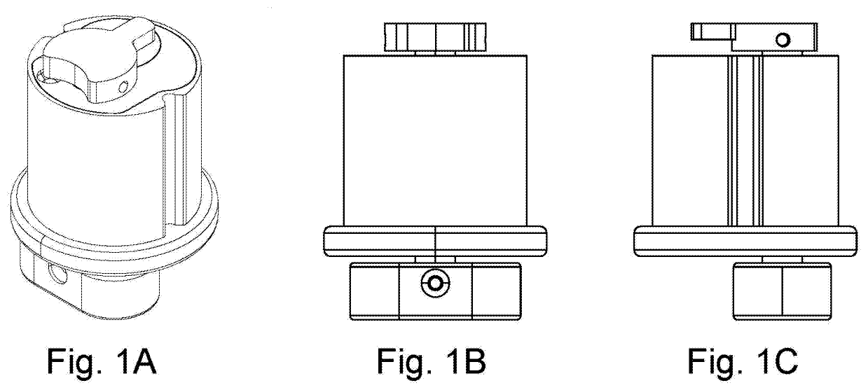

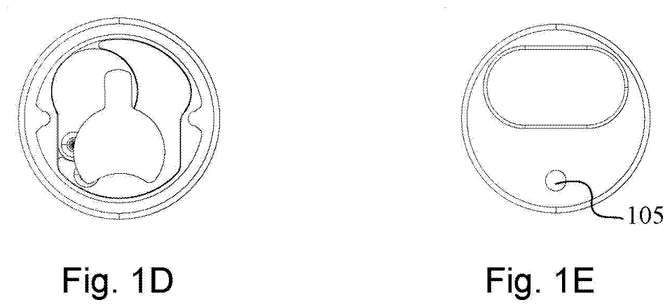

FIGS. 1A-1E depict various views of an example lock. FIG. 1A shows a back perspective view of the lock while FIGS. 1B and 1C respectively depict a first side view and a second side view of the lock. FIGS. 1D and 1E respectively show a back view and a front view of the lock.

In FIG. 1E, the bottom plate of the cylindrical shell 200 (also called shell component) includes a translucent lens 105. The lens 105 is inserted into a groove of the bottom plate of the cylindrical shell 200. This lens 105 may provide a visual indication to a user illustrating a lock status of the lock based on a light device, such as but not limited to a light emitting diode (LED), which is coupled to an electronic circuit and/or a battery within the cylindrical shell 200 of the lock.

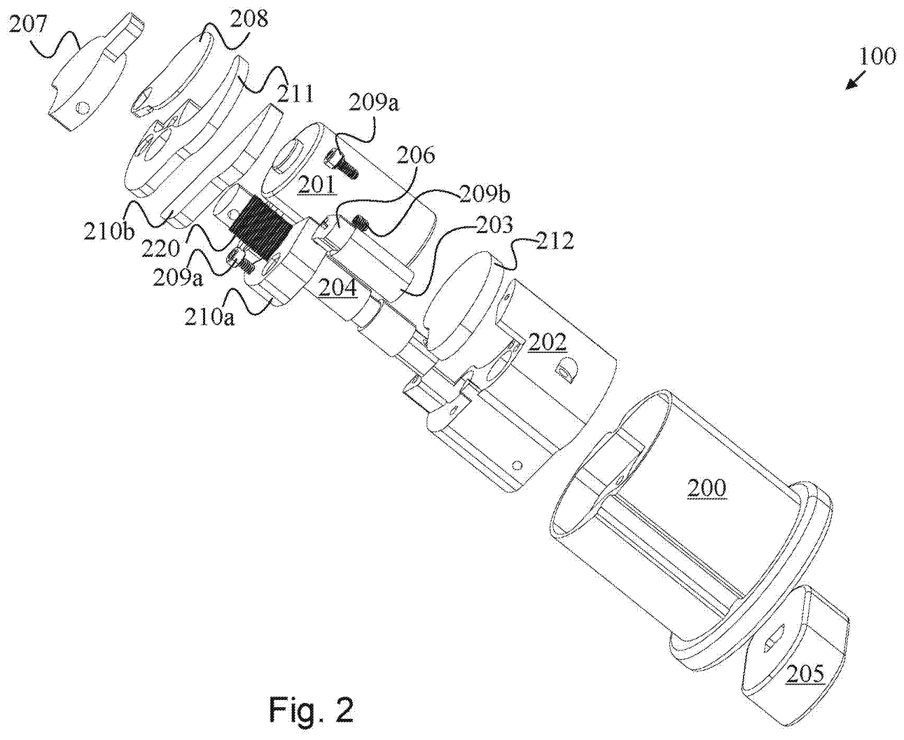

FIG. 2 depicts an exploded view of the lock 100 showing example subcomponents. As shown, the lock 100 comprises a shell component 200, such as a cylindrical housing (although other shapes may also be utilized), that encloses, in some embodiments completely, the rest of the subcomponents, which may comprise mechanical and electrical components.

In some embodiments, the cylindrical housing 200 houses a battery 201, printed circuit board (PCB) 212, insert 202, motor 203, rotor 206, core 204, and cam 207. The lock 100 may also have a handle 205, such as a knob, lever, switch, toggle, etc., that is pressable (e.g., tappable) by a user to wake up or activate the lock 100. In some embodiments, the handle 205 can be turned one direction or another to lock or unlock the lock 100, respectively. In other embodiments, the handle 205 automatically turns in one direction or another based on a wireless actuation of a user device, to lock or unlock the lock 100. This handle 205 may be attached to a front end of the core 204 extending through the front of the lock 100 (see also FIG. 1E).

The core may be spring-loaded and movable inwardly and outwardly relative to the front of the lock. For instance, at an end opposing the lock, a spring 220 may be coupled to the core to provide a counterforce, such that when the core is pressed inwardly by an opposing force, it rebounds to a neutral position once the counterforce is removed, such as after a user has pressed and released the handle. This allows the handle 205, in some embodiments, to be spring loaded to allow it to be restored to its original state after a user presses it. It should be understood that tapping or pressing the handle 205 may activate the lock 100 as noted above. Other means for activating the lock 100 such as voice activation, etc., are also herein contemplated.

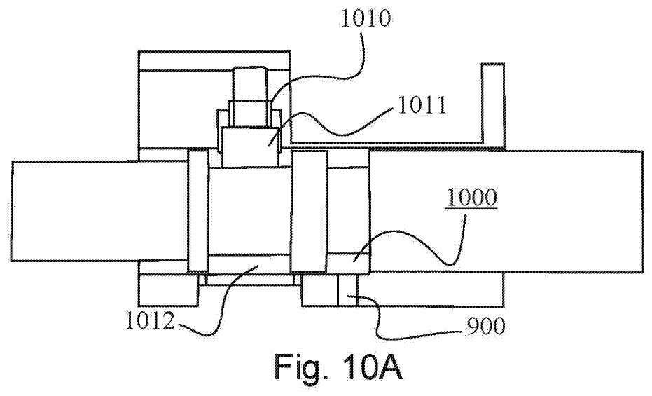

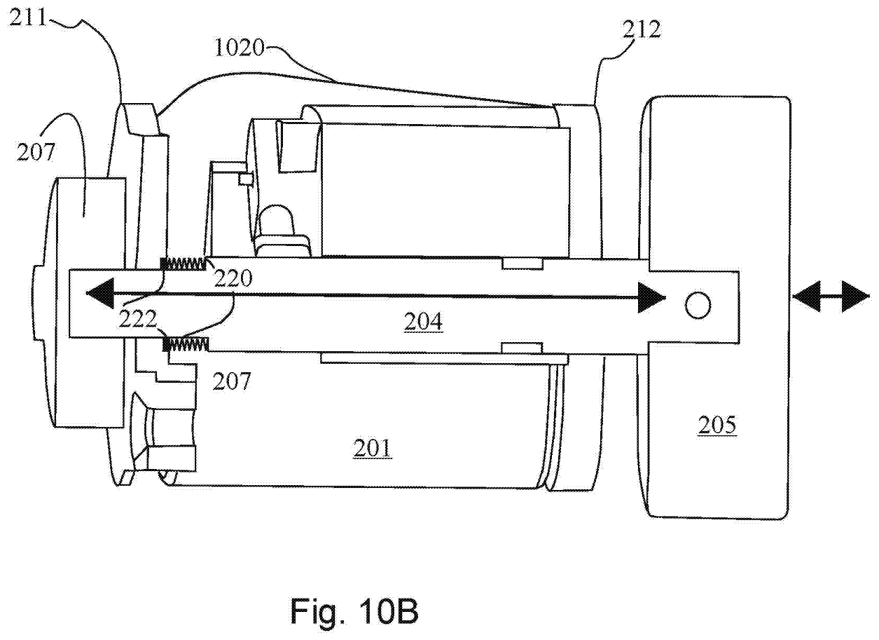

As a further example, FIG. 10B depicts a cutaway view of an example lock showing the activation of the lock. In some embodiments, the spring cap 211 includes a seat 222 on which the spring 220 exerts force. The other end of the spring may be seated against a jog in the core. The jog is a circumference where the core narrows and forms a ledge against which the other end of the spring 220 may rest/exert force, when the spring is compressed. In some embodiments, the seat 222 of the spring cap 211 may include an activation switch that is activated when a sufficient amount of force is exerted by the spring 222 against the switch. Activation of the switch activates a circuit on the PCB 212 responsive to the handle 205 is pressed as shown by the arrows depicted in FIG. 10B.

For example, the activation switch may turn the PCB 212 on via wiring 1020, which may relay an electronic signal to the PCB 212 responsive to activation of the switch/pressing the handle 205. In some embodiments, the spring and/or switch may situated in other areas of the lock, such as near the core hole at the front of the lock. For example, the switch may be closed by the core being situated in a front-most orientation due to the pressure exerted by the spring, and upon the handle being depressed, the core may travel toward the back of the lock, taking pressure off of the switch and thus activating it. The switch may be wired to the PCB and relay activation thereof to activate the lock. Numerous other variations are also possible and contemplated.

PCB 212 may be activated via other signal lines 1020 coupled to other switches other than the switch associated with the spring cap 211.

As noted above, the LED associated with the lens 105 (shown in association with FIG. 1E) may be used to indicate a lock status of the lock 100 after the push/wake mechanism is activated. When the lock 100 is activated, it may transmit a wireless signal (e.g. Bluetooth or the like) to a user device (e.g. Cell phone, PDA, tablet, or the like) to verify/confirm the identity of the user. The user device may in turn transmit an authorization response to the lock 100 confirming that the user is an authorized user who may be granted unlock access. When this happens, the internal locking mechanism of the lock may unlock by turning the rotor 206 into an unlock position. The core 204 may then freely rotate to displace the locking pin 1011 (shown with reference to FIG. 10) which then turns the cam 207 to unlock the lock 100. In some embodiments, a cam adapter (not shown) may allow industry standard cams such as L Lock, Yale, Sargent, Corbin and Adams Rite, etc., to be incorporated into the present design in the absence of the cam 207.

It is to be understood that different core designs other than the core 204 are herein contemplated. Additionally, different rotor designs, which may incorporate an auto relock feature after the core 207 is rotated, are also contemplated.

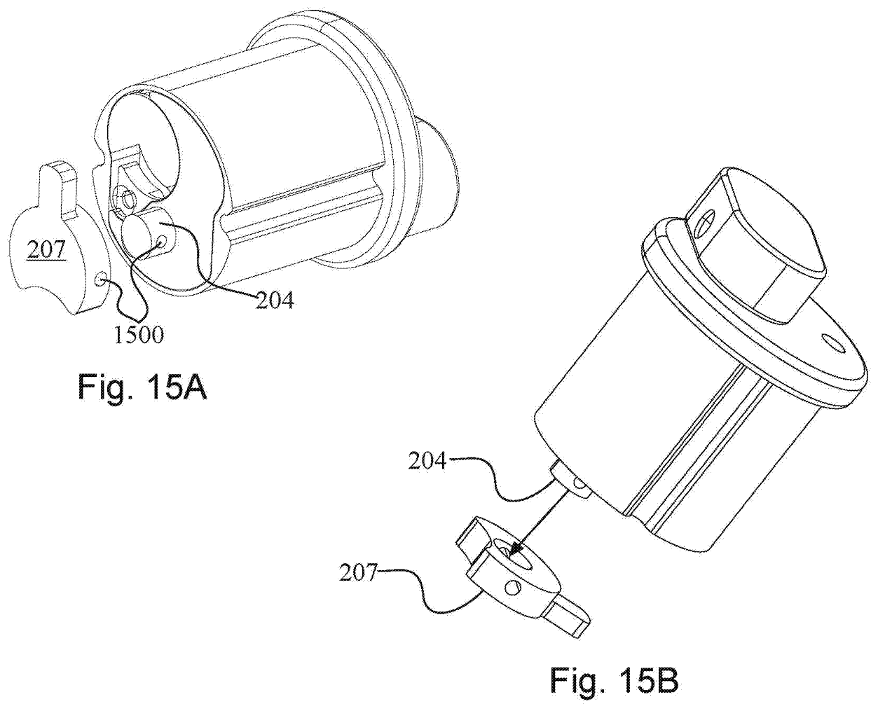

Returning back to FIG. 2, the lock 100 may also include fastening screws 209a . . . 209d which may facilitate positioning and securing in place the other components within the cylinder component 200. In some embodiments, the front view of the lock 100, which is also depicted in FIG. 1E, may include a groove through which the front extremity of the core 204 extends and to which the handle 205 may be coupled to with fastening screws (not shown). This is further discussed in association with FIGS. 15A and 15B.

Also shown in FIG. 2 are alignment members 210a and 210b, and spring cap 211 that may, in some embodiments, facilitate the aligning, securing and positioning of various components of the lock in an efficient manner to satisfy the real estate constraints imposed by the lock design described herein.

FIG. 3 depicts a perspective view of the shell component 200 of the lock 100. As stated above, the shell component 200 may take the form of a mortise cylinder with external threads (not shown) around the external casing of the mortise cylinder. In some embodiments, opposite sides of the external casing of the mortise cylinder may have two notches 300 as shown. This may allow the lock to be securely held into a door or other barrier for correct alignment and stability so that when the handle 205 of the lock is turned, the shell component 200 does not turn as well.

FIG. 4 is a rear view of the shell component 200 of the lock. As can be seen in this view, the shell component 200 may include one or more screw holes 400 that hold the shell component 200 in place after installation. As would be understood by those skilled in lock technology, the structuring of the screw holes associated with the shell component 200 allows for the electronic lock disclosed herein to be compatible with both the mortise cylinder and rim cylinder configurations.

As shown in the figure, the shell component 200 may hold mechanical and electrical components of the lock 100 using cutouts 401. For instance, cutouts 401 of the shell component 200 may accommodate the insert 202, which in this example is a subassembly of components 202a and 202b, battery 201, and other internal components of the lock.

FIG. 4 also shows a hole 402 on the front face of the back view (FIG. 1D). This hole 402 may expose the LED coupled to the electronic circuit/PCB 212 within the shell component 200. The translucent lens 105 of FIG. 1E may be inserted into this hole 402 to highlight an activity status/an activation state of the lock 100 once the lock 100 is in operation.

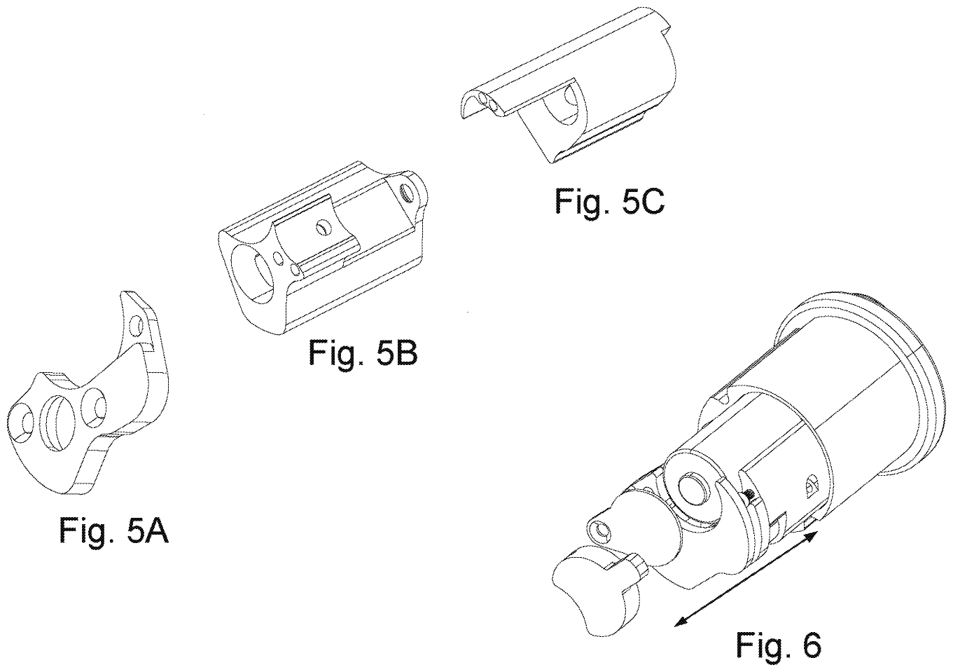

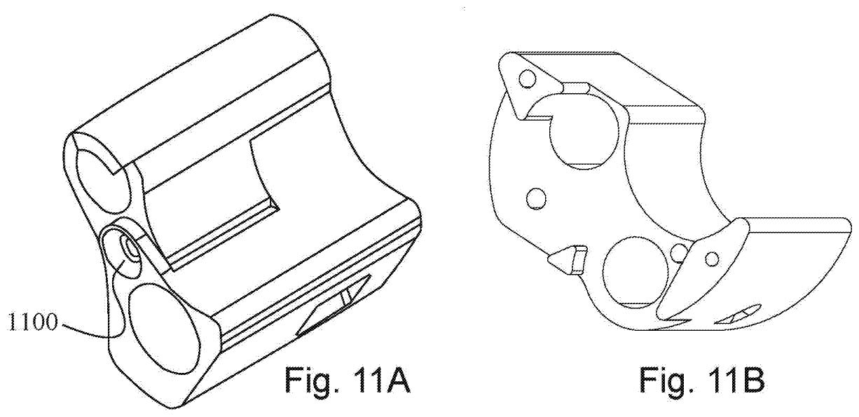

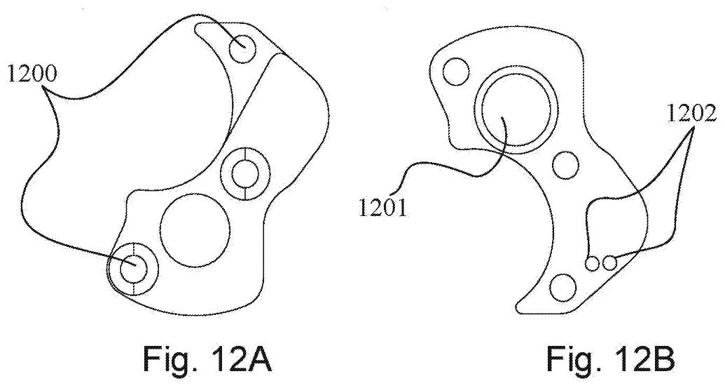

FIGS. 5A-5C show an arrangement of the spring cap 211 in association with an exploded view of the insert 202 of the lock 100. FIG. 5A depicts the spring cap 211 which is further discussed below with reference to FIGS. 12A and 12B. The insert 202, also discussed with reference to FIGS. 11A and 11B, may comprise an assembly of a plurality of parts, such as a core and locking pin member (FIG. 5B), and a motor and rotor member (FIG. 5C). Once all the internal components of the lock (including the spring cap 211 and the insert 202 of FIGS. 5A . . . 5C) are appropriately combined, they can freely slide into the shell component 200 as shown in FIG. 6.

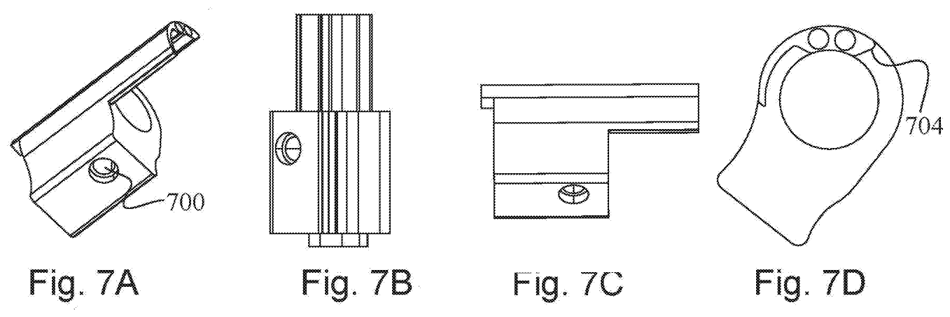

FIGS. 7A-7D depict various views of rotor and motor member. FIGS. 7A . . . 7D show various views of the rotor and motor member (FIG. 5C). A set screw 700 on the bottom of the rotor and motor member may be used to secure the motor to the motor and rotor member. Also, a rotor stop 704 may also be incorporated into the present design to limit the rotation of the rotor 206 between the lock and the unlock positions of the lock 100.

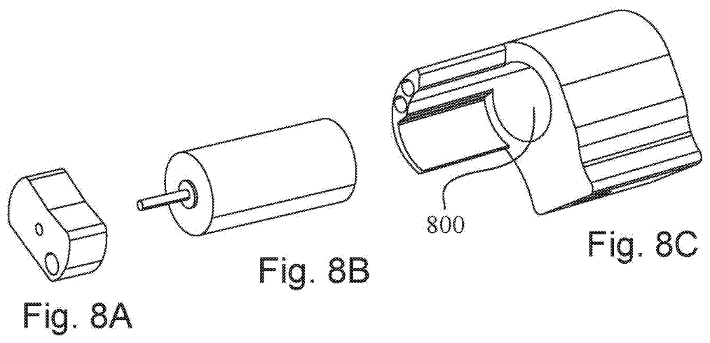

FIGS. 8A-8C show a coupling of the rotor 206 to the motor 203, and an insertion motion of the rotor 206 and motor 203, respectively, into the motor and rotor member. Turning to FIGS. 8A . . . 8C, it can be seen that the rotor 206 (FIG. 8A), may first be installed onto the motor 203 (FIG. 8B), and then inserted into the hole 800 of the motor and rotor member (FIG. 8C).

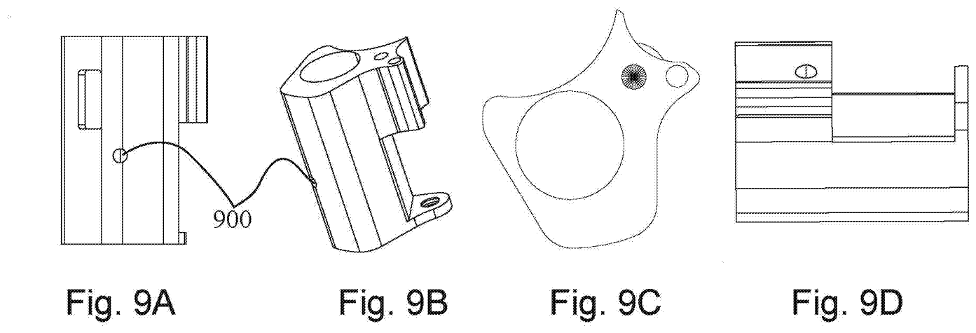

FIGS. 9A-9D depict various views of the core member of FIG. 5B. FIGS. 9A . . . 9D respectively show a front view, a perspective view, a top view and side view of the core member. In some embodiments, the core 204 may be inserted into the core member in a manner that allows it to line up with the set screw hole 900 through which a set screw may be used to secure the core 204 to the bottom of the core member. This securing prevents the core 204 from slipping out of the core member and limits the throw of the core based on the width of the notch 1000 of FIG. 10 while allowing its rotational degree of freedom. In some embodiments, the throw of the core 204 is limited to 0.030 inches for the push/wake mechanism of the lock as described above.

Additionally, the core member of FIGS. 9A-9D also holds the locking pin 1011, and a spring 1010 of FIG. 10. It should be understood that the core member allows the core 204 to spin freely within the shell component 200 of the lock 100.

FIG. 10A is a cutaway view of the internal mechanism of the core member containing the core 204 and locking pin 1011 of the lock. In some embodiments, the core member (FIG. 9) includes a notch 1000 of the core which lines up with the set screw 900 of FIG. 9. Also shown in FIG. 10 is a slot 1012 on the core which lines up with the locking pin 1011 and the spring 1010.

FIGS. 11A and 11B depict perspective views of an example insert subassembly 202 of the lock. In some embodiments, the rotor and motor member (FIGS. 5A and 5B) may be separable and coupleable using any suitable fastener(s) or fastening method(s) (e.g., screws, rivets, welding, gluing, etc.). For example, as show, the coupling is provided using a fasting screw fastened into hole 1100 of FIG. 11A. In further embodiments, the core member and the motor member comprise a single component that accommodates both the motor 203 and the core 204 as shown in FIG. 11B.

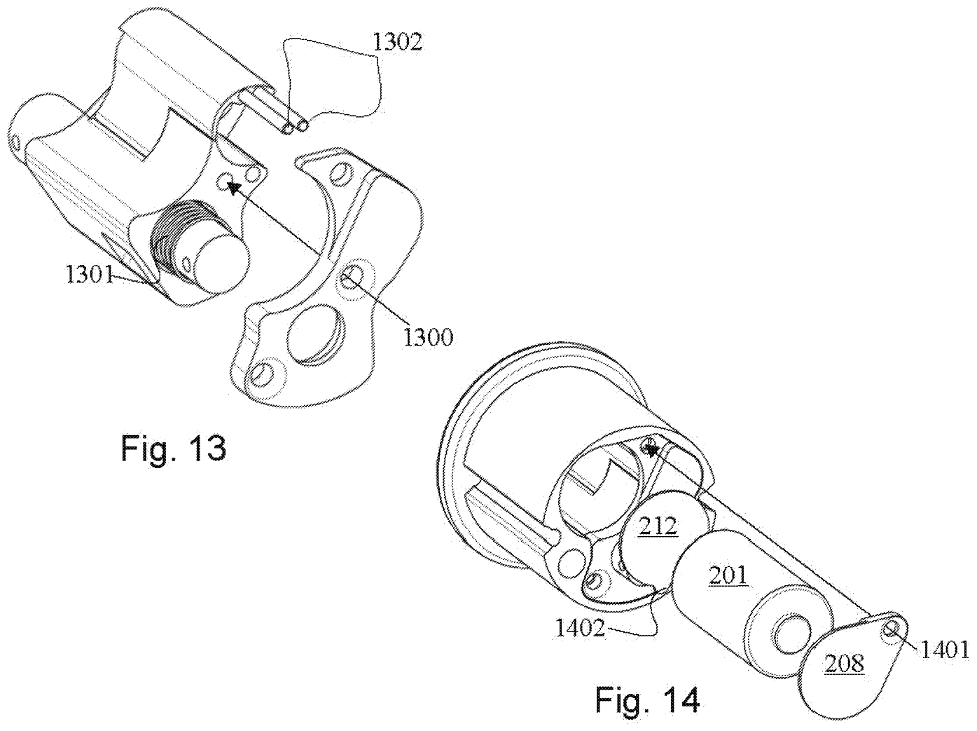

FIGS. 12A and 12B depict views of the spring cap 211 of the lock 100. In some embodiments, the spring cap 211 caps the compression spring 1301 (see FIG. 13) on the core 204 onto the insert 202 within the shell component 200. In further embodiments, the spring cap 211 may be secured to the insert 202 using one or more suitable fasteners or fastening methods, such as but not limited to, screw 1300 and the two diameter dowel pins 1302 (shown in FIG. 13), which in the depicted case, align with two grooves 1202 of the spring cap of FIG. 12B. The compression spring 1301 (simply referred to as spring 220 elsewhere herein) pushes against the spring cap 202b and keeps the core 204 at a default ‘pushed out’ position for the push to wake mechanism which is described elsewhere herein. The spring cap 211 also provides locations 1200 (shown in FIG. 12A) where the spring cap 211 may be fastened to the shell component 200.

FIG. 13 shows a view of the spring cap being coupled to the insert 202 having the compression spring 1301 and alignment dowel pins 1302 of the lock 100. The various features of the lock in this figure are discussed in association with FIG. 12.

FIG. 14 shows a view of the PCB 212, battery 201, and a battery cap 208 being coupled to the shell component 200 of the lock 100. As shown in the figure, the battery 201 and the PCB 212 can slide freely into a cut out of the shell component 200 already fitted with the insert 202. In some embodiments, the PCB 212 has a circular profile shape that corresponds to the shape of the battery 201, such that it can be abuttedly aligned with the battery 201 within the cutout to minimize the real estate taken up within the shell component 200.

In some embodiments, the PCB 212 includes circuitry that facilitate wireless communication between the lock 100 and a user device. For instance, the PCB 212 of the lock 100 may communicate with the user device via Bluetooth, Bluetooth for lower-powered devices (BLE), ZigBee, Z-wave, 6LoWPAN, Thread, Wi-Fi-ah/HaLow, WirelessHART, Wi-Fi, cellular (e.g., 3G, 4G, 5G, etc.) or any other suitable wireless protocol. It should be understood that the communication between the PCB of the lock 100 and the user device is for authenticating the user, among other things. In some cases, the PCB 212 may have logic that facilitate the electro-mechanical operation of the lock. This logic may reside on a non-transitory memory of the PCB 212. In some embodiments, the logic within the non-transitory memory may be updated using any suitable program update technique, either wirelessly or using a wired connection to the electronic circuit.

The light indicator may comprise any suitable light source, such as bulb, a display, etc. In some embodiments, the light indicator may display different colors, shapes, symbols, graphics, text, etc., to reflect a state of the lock. In the depicted embodiment, the light indicator comprises an LED. As shown, the LED may be included in the electronic circuit of the lock, such as the PCB 212. In the depicted embodiment, the LED aligns with the groove within which the translucent lens 105 is inserted. In some embodiments, this alignment is facilitated using a positive alignment mark 1402 which also serves as a battery contact for the PCB 212. Once the battery 201 is inserted into the shell component 200, the battery cap 208 secures the battery 201 to the shell component 200 via a screw 1401. In some embodiments, this screw secures the battery cap 208, and the insert 202 and the battery cap 208, to the shell component 200.

FIGS. 15A and 15B show perspective views of a coupling of the core 204 to the cam 207 of the lock 100. In some embodiments, the cam 207 may be coupled to the core 204 using screw grooves 1500 into which a screw(s) can be screwed (FIG. 15A). FIG. 15B provides a view that illustrates how the back extremity of the core 204 may be inserted into the cam 207 with the screw grooves 1500 being aligned to facilitate the screwing of the fasting screw(s) that couple the core 204 to the cam 207.

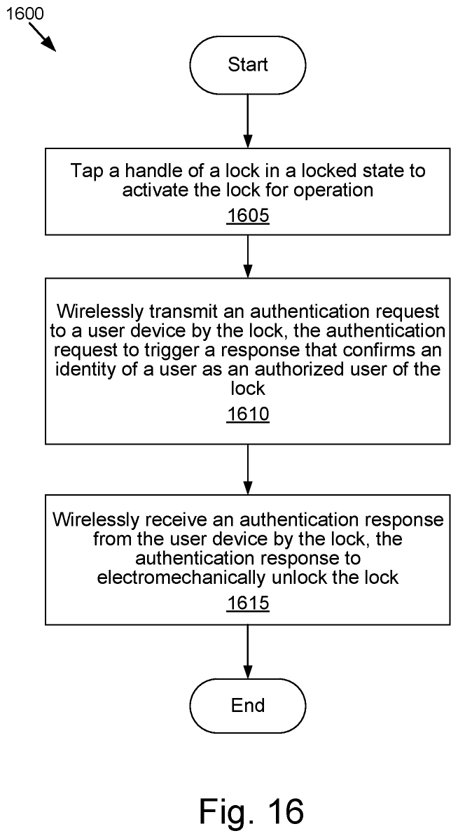

FIG. 16 is a flowchart illustrating a method 1600 for actuation a lock. The foregoing may also be practiced in the form of methods. In an example method, a method of lock actuation 1600 comprises a step 1605 for tapping a handle of a lock in a locked state, wherein tapping the handle activates the lock for operation. The method 1600 further includes a step 1610 for wirelessly transmitting an authentication request to a user device by the lock, the authentication request triggering a response that confirms the identity of a user as an authorized user of the lock. The method 1600 further includes a step 1615 for wirelessly receiving an authentication response from the user device by the lock, the authentication response electromechanically unlocking the lock.

The method may further comprise turning the lock mechanism by a rotor to an unlocked position, turning the lock mechanism by the rotor to a locked position, and temporarily maintaining the rotor in an intermediate state between the locked state and the unlock state. The method wherein the intermediate state is bi-stable. The method further comprising indicating a lock state of the lock using an electronic indicator, the electronic indicator being responsive to an electronic circuit. The method further comprising emitting light through a light aperture on a front surface of the cylindrical housing. The method further comprising responsive to the user moving the handle, activating the electronic indicator to indicate one of the locked state of the lock and the unlocked state of the lock. The method further comprising inwardly moving the handle relative to the front side to activate a switch of the electronic circuit to activate the lock. The method further comprising pressing the handle inwardly to create a contact between a spring loaded core and a switch of the electronic circuit; and activating the lock in response to the contact. The method further comprising self-aligning an electronic circuit when inserted into a cylindrical housing.

The foregoing description, for purposes of explanation, has been provided with reference to various embodiments and examples. However, the illustrative discussions above are not intended to be exhaustive or limited to the precise forms of the lock disclosed herein. Many modifications and variations are possible in view of the above teachings. The various embodiments and examples were chosen and described in order to best explain the principles upon which the design of the lock 100 is based. Practical applications of the above concepts by one skilled in the art that utilize the above innovative technology with various modifications as may be suited to the particular use are contemplated.

What is claimed is:

1. A lock comprising:
a cylindrical housing that houses at least:
a replaceable battery,
a lock mechanism,
an electronic circuit powered by the replaceable battery, the electronic circuit being configured to authenticate a user and electro-mechanically actuate the lock mechanism of the lock responsive to being activated, and
a rotor coupled to the lock mechanism of the lock, the rotor being powered by the replaceable battery and configured to situate the lock mechanism based on a lock state of the lock; and
a handle situated outside the cylindrical housing on a front side of the cylindrical housing, the handle being coupled to the lock mechanism, the handle being configured to activate the lock responsive to the user moving the handle.

2. The lock of claim 1, wherein
the lock state includes one of:
an unlocked state where the rotor turns the lock mechanism to an unlocked position,
a locked state where the rotor turns the lock mechanism to a locked position, and
an intermediate state where the rotor is temporarily situated between the locked state and the unlock state.

3. The lock of claim 2, wherein the intermediate state is bi-stable.

4. The lock of claim 1, wherein:
a proximal end of the cylindrical housing includes a front surface of the lock, the front surface including an electronic indicator indicating a lock state of the lock, the electronic indicator being coupled to the electronic circuit, the front surface further including an aperture through which the handle is coupled to a core of the cylinder,
the cylindrical housing includes a cylindrical cavity at a distal end that houses subcomponents of the lock including the replaceable battery, the locking mechanism, the rotor, and at least a portion of the electronic circuit, and
the subcomponents housed by the cylindrical housing are inaccessible from the proximal end and accessible from the distal end.

5. The lock of claim 4, wherein:
the front surface includes a light aperture, and
the electronic indicator is oriented in the cylindrical housing by an alignment mechanism such that the electronic indicator emits light through the light aperture.

6. The lock of claim 4, wherein:
responsive to the user moving the handle, the electronic circuit activates the electronic indicator to indicate one of a locked state of the lock and an unlocked state of the lock.

7. The lock of claim 1, wherein:
the cylindrical housing further houses a switch situated adjacent to the lock mechanism, and
to activate the lock, the handle is inwardly movable relative to the front side to activate the switch of the electronic circuit.

8. The lock of claim 1, wherein the lock mechanism comprises a spring-loaded core, the handle is coupled to a first end of the spring loaded core, and pressing the handle inwardly creates a contact between the core and a switch of the electronic circuit to activate the lock.

9. The lock of claim 1, wherein
at least a portion of the electronic circuit includes a circuit board having a protruding alignment tab that self-aligns the electronic circuit when inserted into the cylindrical housing.

10. A method of lock actuation, comprising:
tapping a handle of a lock in a locked state, wherein tapping the handle activates the lock for operation;
wirelessly transmitting an authentication request to a user device by the lock, the authentication request triggering a response that confirms an identity of a user as an authorized user of the lock; and
wirelessly receiving an authentication response from the user device by the lock, the authentication response electromechanically unlocking the lock.

11. The method of claim 10, further comprising:
turning a lock mechanism by a rotor to an unlocked position,
turning the lock mechanism by the rotor to a locked position, and
temporarily maintaining the rotor in an intermediate state between the locked state and an unlock state.

12. The method of claim 11, wherein the intermediate state is bi-stable.

13. The method of claim 10, further comprising:
indicating a lock state of the lock using an electronic indicator, the electronic indicator being responsive to an electronic circuit.

14. The method of claim 13, further comprising:
emitting light through a light aperture on a front surface of the cylindrical housing.

15. The method of claim 13, further comprising:
responsive to the user moving the handle, activating the electronic indicator to indicate one of the locked state of the lock and the unlocked state of the lock.

16. The method of claim 10, further comprising:
inwardly moving the handle relative to a front side to activate a switch of an electronic circuit to activate the lock.

17. The method of claim 10, further comprising:
pressing the handle inwardly to create a contact between a spring loaded core and a switch of the electronic circuit; and
activating the lock in response to the contact.

18. The method of claim 10, further comprising:
prior to lock actuation, self-aligning an electronic circuit when inserted into a cylindrical housing.

19. A lock, comprising:
a cylindrical housing that houses at least:
a lock mechanism,
an electronic circuit, the electronic circuit configured to authenticate a user and electro-mechanically actuate the lock mechanism of the lock responsive to being activated, and
a rotor coupled to the lock mechanism of the lock, the rotor configured to situate the lock mechanism based on a lock state of the lock; and
a handle coupled to the lock mechanism to activate the lock responsive to the user moving the handle.

20. The lock of claim 19, comprising:
the lock state includes one of:
an unlocked state where the rotor turns the lock mechanism to an unlocked position,
a locked state where the rotor turns the lock mechanism to a locked position, and
an intermediate state where the rotor is temporarily situated between the locked state and the unlock state.
